(19) United States
(12) Patent Application Publication
(10) Pub. No.: US 2022/0222232 A1
(43) Pub. Date: Jul. 14, 2022

(54) DATA MANAGEMENT DEVICE, CONTROL METHOD, AND STORAGE MEDIUM

(71) Applicant: NEC Corporation, Minato-ku, Tokyo (JP)

(72) Inventors: Satoshi YOSHIDA, Tokyo (JP); Jianquan LIU, Tokyo (JP); Shoji NISHIMURA, Tokyo (JP)

(73) Assignee: NEC Corporation, Minato-ku, Tokyo (JP)

(21) Appl. No.: 17/612,275

(22) PCT Filed: May 8, 2020
(86) PCT No.: PCT/JP2020/018703

§ 371 Date: Nov. 18, 2021

(30) Foreign Application Priority Data
May 27, 2019 (JP) 2019-098792

(51) Int. Cl. G06F 16/22

(52) U.S. Cl. CPC G06F 16/2246

(57) ABSTRACT

A data management apparatus (2000) is accessible to a first storage region (50) and a first storage region (50). The first storage region (50) stores tree structure data (10). The tree structure data (10) have, as a node, a data set (20) being a set of data (40). A second storage region (60) stores a data set (20) not being included in the tree structure data (10). The data management apparatus (2000) acquires data (40) to be inserted into a data set (20), and inserts the data (40) into the data set (20) being already stored in the first storage region (50) or the second storage region (60), or generates a new data set (20) in the second storage region (60) and inserts the data (40) into the generated data set (20). Further, the data management apparatus (2000) inserts one or more of the data sets (20) into the tree structure data (10), when a predetermined condition is satisfied regarding the data set (20) stored in the second storage region (60).

### TECHNICAL FIELD

The present invention relates to management of tree structure data.

### BACKGROUND ART

There are tree structure data, as one of data structures for managing data. For example, data of a tree structure are used as an index tree or the like in a database. For example, Patent Document 1 discloses a similarity tree in which feature value data are handled as an element, and a position of each element is determined based on similarity of feature value data.

### RELATED DOCUMENT

### Patent Document

[Patent Document 1] International Publication No. WO2014/109127

### DISCLOSURE OF THE INVENTION

### Technical Problem

The inventors of the present application found that a scheme is necessary for insertion of an element into tree structure data at a time of handling a set as an element of tree structure data. The present invention has been made in view of the above problem, and one of objects of the present invention is to provide a technique for appropriately inserting an element in tree structure data in which a set is an element.

### Solution to Problem

A data management apparatus according to the present invention is accessible to a first storage region in which tree structure data being data of a tree structure having a data set as a node are stored, and a second storage region in which a data set not being included in the tree structure data is stored.

The data management apparatus includes: 1) a data insertion unit that acquires data to be inserted into the data set, and inserts the acquired data into the data set being already stored in the first storage region or the second storage region, or generates a new data set in the second storage region and inserts the acquired data into the generated data set; and 2) a set insertion unit that inserts, into the tree structure data, one or more of the data sets stored in the second storage region, when a predetermined condition is satisfied regarding the data set stored in the second storage region.

A control method according to the present invention is executed by a computer. The computer is accessible to a first storage region in which tree structure data being data of a tree structure having a data set as a node are stored, and a second storage region in which a data set not being included in the tree structure data is stored.

The control method includes: 1) a data insertion step of acquiring data to be inserted into the data set, and inserting the acquired data into the data set being already stored in the first storage region or the second storage region, or generating a new data set in the second storage region and inserting the acquired data into the generated data set; and 2) a set insertion step of inserting, into the tree structure data, one or more of the data sets stored in the second storage region, when a predetermined condition is satisfied regarding the data set stored in the second storage region.

A program according to the present invention causes a computer to execute each of the steps included in the control method according to the present invention.

### Advantageous Effects of Invention

The present invention provides a technique for appropriately inserting an element in tree structure data in which a set is an element.

### BRIEF DESCRIPTION OF DRAWINGS

The above-described object, the other objects, features, and advantages will become more apparent from a suitable example embodiment described below and the following accompanying drawings.

FIG. 1 is a diagram for describing an overview of a data management apparatus according to a present example embodiment.

FIG. 2 is a diagram illustrating a functional configuration of a data management apparatus according to an example embodiment 1.

FIG. 3 is a diagram illustrating a computer for achieving the data management apparatus.

FIG. 4 is a flowchart illustrating a flow of processing to be executed by the data management apparatus according to the example embodiment 1.

FIG. 5 is a diagram illustrating a more specific use scene of the data management apparatus.

FIG. 6 is a diagram illustrating tree structure data to be achieved as a similarity tree.

### DESCRIPTION OF EMBODIMENTS

Hereinafter, an example embodiment according to the present invention is described with reference to the drawings. Note that, in all the drawings, a similar constituent element is indicated by a similar reference sign, and description thereof is omitted as necessary. In each block diagram, unless otherwise specifically described, each block does not represent a configuration of a hardware unit, but represents a configuration of a functional unit.

### Example Embodiment 1

### Overview

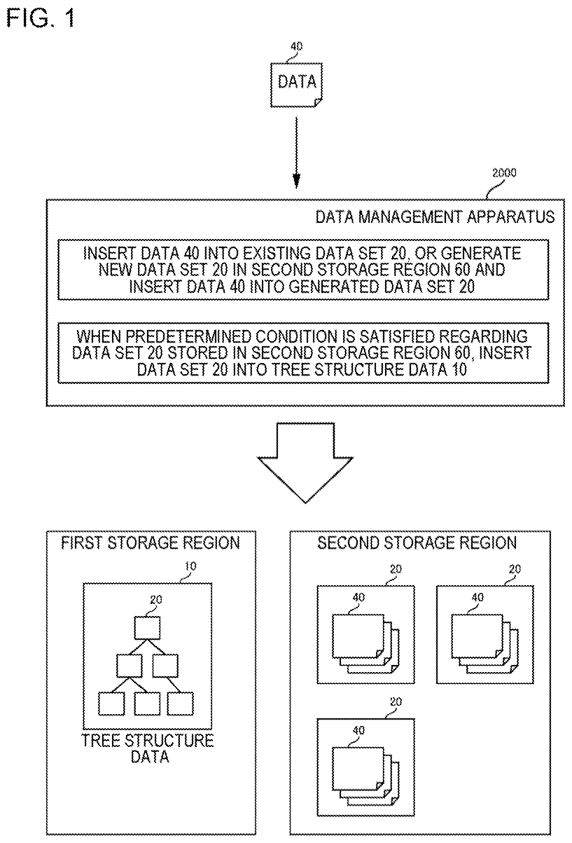

FIG. 1 is a diagram for describing an overview of a data management apparatus 2000 according to a present example embodiment. Note that, FIG. 1 is an example for facilitating understanding of the data management apparatus 2000, and a function of the data management apparatus 2000 is not limited to the one illustrated in FIG. 1.

The data management apparatus 2000 performs management of tree structure data 10 being data of a tree structure. For example, the data management apparatus 2000 performs insertion of data into the tree structure data 10. The tree structure data 10 constitute a tree structure by a plurality of nodes 12. For example, the tree structure data 10 have a structure of a similarity tree disclosed in International Publication No. WO2014/109127.

The tree structure data 10 include a data set 20, as a node. The data set 20 is a set including one or more pieces of data 40. As the data 40, data of any type can be adopted. For example, as the data 40, an image feature (feature value on an image) of an object such as a person extracted from a moving image frame can be adopted. It is preferable to include, in one data set 20, pieces of data 40 being similar to each other. For example, it is assumed that an image feature of an object is used as data 40. In this case, a plurality of image features acquired from a same object are designed to be collected in one data set 20.

The tree structure data 10 are stored in a first storage region 50. The first storage region 50 is a storage region of a part or the entirety of any storage apparatus. The first storage region 50 may be constituted of a plurality of storage apparatuses. Further, a second storage region 60 is also prepared as another storage region in which a data set 20 not constituting the tree structure data 10 is stored. The second storage region 60 is a storage region of a part or the entirety of any storage apparatus, similarly to the first storage region 50. The second storage region 60 may be constituted of a plurality of storage apparatuses. As the first storage region 50 and the second storage region 60, a same storage apparatus may be used, or storage apparatuses different from each other may be used.

After acquiring new data 40 to be managed, the data management apparatus 2000 inserts the data 40 into one of existing data sets 20, or generates a new data set 20 in the second storage region 60 and inserts the data 40 into the second storage region 60. Further, when a predetermined condition is satisfied regarding a data set 20 stored in the second storage region 60, the data management apparatus 2000 inserts, into the tree structure data 10, one or more of the data sets 20 stored in the second storage region 60. By insertion into the tree structure data 10, the data set 20 is not stored in the second storage region 60 but is stored in the first storage region 50. Hereinafter, the above-described predetermined condition is referred to as an insertion condition.

### <Representative Advantageous Effects>

In a case where an element (corresponding to data 40) is inserted into data of a tree structure, an appropriate position within the tree structure is determined according to a property of the element, and the element is inserted at the position. Further, reconfiguration of the tree structure is performed as necessary.

However, in a case where a data set is handled as an element, it is difficult to determine an appropriate position of the data set at a time immediately after generation of the data set. This is because, when the number of pieces of data is less within a data set or during a time when the data set is frequently updated, a property of the data set (e.g., an average, dispersion, or the like of data included in the data set) may be affected by data to be newly inserted and greatly change. When a data set cannot be inserted at an appropriate position, performance such as data retrieval thereafter may be lowered.

In the data management apparatus 2000 according to the present example embodiment, a data set 20 is inserted into the tree structure data 10 in response to satisfaction of the insertion condition (predetermined condition regarding a data set 20 stored in the second storage region 60). In other words, a data set 20 is not inserted into the tree structure data 10 immediately after generation, but is temporarily stored in the second storage region 60. Therefore, by setting an appropriate insertion condition, which is satisfied after a property of a data set 20 is secured to some extent, the data set 20 is inserted into the tree structure data 10 after it becomes possible to appropriately determine a position in the tree structure data 10. Therefore, it becomes possible to insert an element at an appropriate position in tree structure data in which a data set is handled as an element. Consequently, for example, it is possible to improve performance of data retrieval using the tree structure data 10.

Hereinafter, further details of the present example embodiment are described.

### <Example of Functional Configuration>

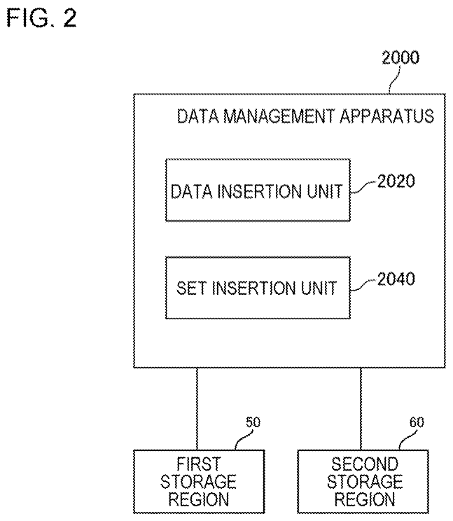

FIG. 2 is a diagram illustrating a functional configuration of the data management apparatus 2000 according to the example embodiment 1. The data management apparatus 2000 is accessible to the first storage region 50 and the second storage region 60. The data management apparatus 2000 includes a data insertion unit 2020 and a set insertion unit 2040. The data insertion unit 2020 acquires data 40. Further, the data insertion unit 2020 1) inserts the data 40 into a data set 20 being already stored in the first storage region 50 or the second storage region 60, or 2) generates a new data set 20 in the second storage region 60 and inserts the data 40 into the generated data set 20. When an insertion condition is satisfied, the set insertion unit 2040 inserts, into the tree structure data 10, one or more of the data sets 20 stored in the second storage region 60.

### <Example of Hardware Configuration of Data Management Apparatus 2000>

Each functional configuration unit of the data management apparatus 2000 may be achieved by hardware (example: a hard-wired electronic circuit, and the like) that achieves each functional configuration unit, or may be achieved by combination of hardware and software (example: combination of an electronic circuit, and a program that controls the electronic circuit, and the like). Hereinafter, a case is further described in which each functional configuration unit of the data management apparatus 2000 is achieved by combination of hardware and software.

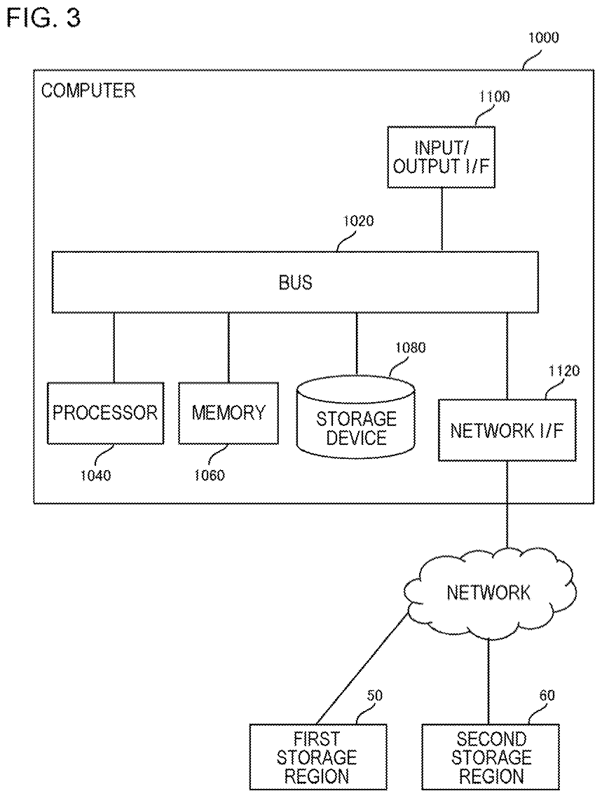

FIG. 3 is a diagram illustrating a computer 1000 for achieving the data management apparatus 2000. The computer 1000 is any computer. For example, the computer 1000 is any computer. For example, the computer 1000 is a stationary type computer such as a server machine and a personal computer (PC). In addition to the above, for example, the computer 1000 may be a portable computer such as a smartphone and a tablet terminal.

The computer 1000 may be a dedicated computer designed for achieving the data management apparatus 2000, or may be a general-purpose computer. In a case where the computer 1000 is a general-purpose computer, it is preferable to cause the computer 1000 to function as the data management apparatus 2000 by installing a predetermined program in the computer 1000.

The computer 1000 includes a bus 1020, a processor 1040, a memory 1060, a storage device 1080, an input/output interface 1100, and a network interface 1120. The bus 1020 is a data transmission path along which the processor 1040, the memory 1060, the storage device 1080, the input/output interface 1100, and the network interface 1120 mutually transmit and receive data. However, a method of mutually connecting the processor 1040 and the like is not limited to bus connection.

The processor 1040 is a variety of processors such as a central processing unit (CPU), a graphics processing unit (GPU), and a field-programmable gate array (FPGA). The memory 1060 is a main storage apparatus to be achieved by using a random access memory (RAM) or the like. The storage device 1080 is an auxiliary storage apparatus to be achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard, and an output apparatus such as a display apparatus are connected to the input/output interface 1100.

The network interface 1120 is an interface for connecting the computer 1000 to a network. A method of connecting the network interface 1120 to a network may be wireless connection or may be wired connection.

The computer 1000 is connected to the first storage region 50 and the second storage region 60 via the network interface 1120. However, a method of connecting the computer 1000 to the first storage region 50 and the second storage region 60 is not limited to a method via the network interface 1120. For example, the first storage region 50 and the second storage region 60 may be connected to the computer 1000 via the input/output interface 1100. The first storage region 50 and the second storage region 60 may be provided inside the computer 1000 (e.g., inside the storage device 1080).

The storage device 1080 stores a program module that achieves each functional configuration unit of the data management apparatus 2000. The processor 1040 achieves a function associated with each program module by reading each of these program modules in the memory 1060 and executing each of these program modules.

### <Flow of Processing>

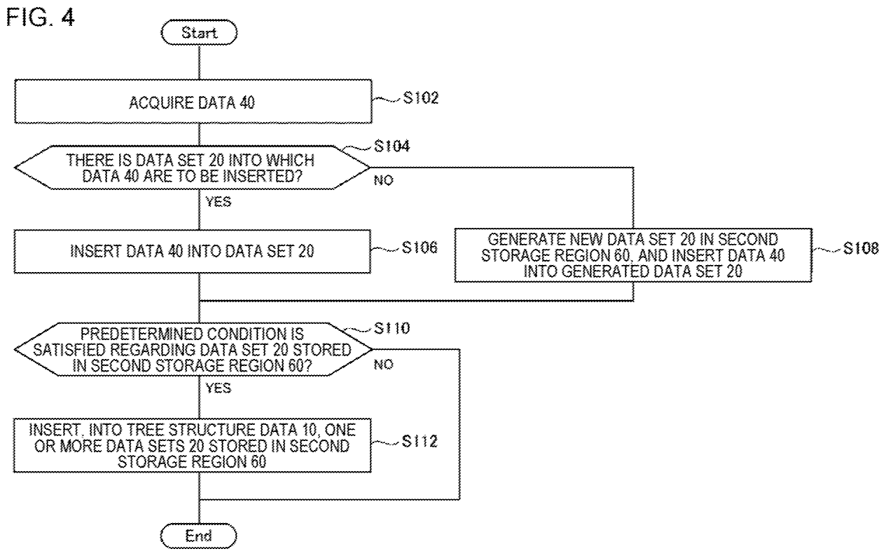

FIG. 4 is a flowchart illustrating a flow of processing to be executed by the data management apparatus 2000 according to the example embodiment 1. The data insertion unit 2020 acquires data 40 (S102). The data insertion unit 2020 determines, from among the data sets 20 already being stored in the first storage region 50 or the second storage region 60, whether there is a data set 20 into which the data 40 are to be inserted (S104). In a case where there is a data set 20 into which the data 40 are to be inserted (S104: YES), the data insertion unit 2020 inserts the data 40 into the data set 20 (S106). On the other hand, in a case where there is no data set 20 into which the data 40 are to be inserted (S104: YES), the data insertion unit 2020 generates a new data set 20 in the second storage region 60, and inserts the data 40 into the generated data set 20 (S108).

The set insertion unit 2040 determines whether the insertion condition is satisfied (S110). In a case where the insertion condition is not satisfied (S110: NO), processing of FIG. 4 ends. On the other hand, in a case where the insertion condition is satisfied (S110: YES), the set insertion unit 2040 inserts, into the tree structure data 10, one or more of the data sets 20 stored in the second storage region 60 (S112).

### <Example of Use Scene>

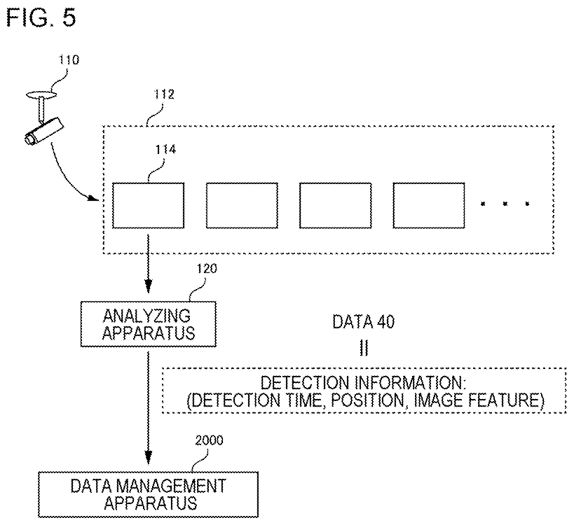

FIG. 5 is a diagram illustrating a more specific use scene of the data management apparatus 2000. In this example, information indicating an image feature of an object to be detected from moving image data is handled as data 40. Hereinafter, this is described more specifically.

An analyzing apparatus 120 acquires moving image data 112 generated by a camera 110, and performs an image analysis regarding each of moving image frames 114 constituting the moving image data 112. More specifically, the analyzing apparatus 120 detects an object from a moving image frame 114, and generates detection information being information relating to the object. For example, detection information is information including a detection time (generation time of a moving image frame), a position of an object on a moving image frame 114, and an image feature of an object. Detection information is generated regarding each object to be detected from a moving image frame 114.

The analyzing apparatus 120 transmits the detection information to the data management apparatus 2000. The data management apparatus 2000 (data insertion unit 2020) acquires the detection information as data 40. The data management apparatus 2000 performs management of data 40 in such a way that data 40 regarding a same object are included in a same data set 20. Note that, detection information to be acquired as data 40 by the data management apparatus 2000 may be limited to the one regarding an object of a specific type (e.g., a person).

The data management apparatus 2000 manages data 40 in such a way that a plurality of pieces of data 40 similar to one another are included in a same data set 20. Herein, in a case where the above-described detection information is handled as data 40, similarity between pieces of data 40 is computed based on an image feature indicated by detection information. This enables managing detection information being information relating to an object extracted from moving image data 112 in such a way that detection information in which an image feature is similar to each other is included in a same data set 20. Specifically, it is possible to collect and manage, in a same data set 20, a plurality of image features to be acquired regarding a same person.

Managing data as described above enables, for example, finding, from data managed by the data management apparatus 2000, a person having an image feature by retrieval by way of a retrieval query including the image feature. Details of data retrieval will be described later.

### <Acquisition of Data 40: S102>

The data insertion unit 2020 acquires data 40 to be inserted into a data set 20 (S102). Herein, there are a variety of methods of acquiring data 40. For example, as exemplified by the above-described use scene, the data insertion unit 2020 acquires data 40 by receiving the data 40 transmitted from another apparatus. In addition to the above, for example, the data insertion unit 2020 acquires data 40 stored in another storage region other than the first storage region 50 and the second storage region 60 by accessing to the another storage region. For example, in the above-described use scene, a storage apparatus to be shared by the analyzing apparatus 120 and the data management apparatus 2000 is provided, and the analyzing apparatus 120 stores detection information in the storage apparatus. Then, the data insertion unit 2020 acquires, as data 40, the detection information stored in the storage apparatus. In addition to the above, for example, the data insertion unit 2020 may acquire data 40 input by a user.

<Determination as to Whether there is Data Set 20 into which Data 40 are to be Inserted: S104>

The data insertion unit 2020 determines whether there is a data set 20 into which the acquired data 40 are to be inserted (S104). Various criteria can be used for the determination.

For example, regarding an existing data set 20, representative data of the data set 20 are computed in advance. For example, representative data of a data set 20 are a statistical value (such as an average value) of data included in the data set 20. Note that, in a case where data 40 are vector data, representative data thereof also become vector data (e.g., an average vector).

The data insertion unit 2020 determines, from among the existing data sets 20, a data set 20 in which similarity between data 40 and representative data thereof is equal to or more than a predetermined threshold value. It is possible to use, as similarity between data, a value (e.g., a reciprocal of a norm) that increases, as the norm between data decreases. Note that, as the norm, a norm of any type (such as an L1 norm and an L2 norm) can be adopted.

In a case where there is, within the existing data sets 20, a data set 20 in which similarity to data 40 is equal to or more than the predetermined threshold value, the data insertion unit 2020 determines the data set 20, as a data set 20 into which the data 40 are to be inserted. On the other hand, in a case where there is, within the existing data sets 20, no data set 20 in which similarity to data 40 is equal to or more than the predetermined threshold value, the data insertion unit 2020 determines that there is no data set 20 into which the data 40 are to be inserted.

Note that, it is preferable to preferentially perform, from the tree structure data 10, retrieval of a data set in which similarity to data 40 is equal to or more than a predetermined threshold value. This is because it is possible to perform retrieval at a high speed, since the tree structure data 10 are data of a tree structure. Note that, retrieval of the tree structure data 10 can be performed in accordance with an algorithm being determined in advance depending on a type of the tree structure data 10. Hereinafter, retrieval of a similarity tree is described as an example.

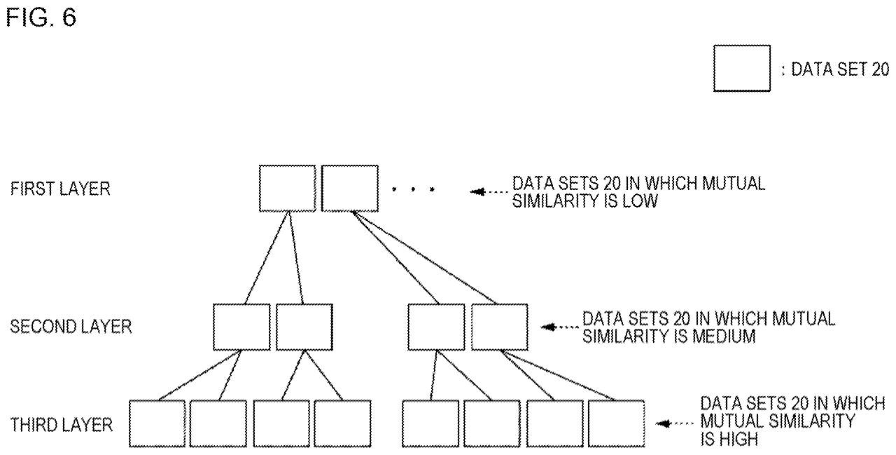

FIG. 6 is a diagram illustrating a tree structure data 10 to be achieved as a similarity tree. In FIG. 6, the tree structure data 10 are a similarity tree of three hierarchies. The three hierarchies are referred to as a first layer, a second layer, and a third layer in this order from the upper side. In the third layer, all data sets 20 inserted into the tree structure data 10 are arranged. In the second layer, one of a plurality of data sets 20 immediately below the layer is arranged. Likewise, in the third layer, one of a plurality of data sets 20 immediately below the layer is arranged.

Herein, in the first layer, data sets 20 whose mutual similarity is low are arranged. On the other hand, in the second layer, a plurality of data sets 20 whose mutual similarity is medium are arranged immediately below a same data set 20. Further, in the third layer, a plurality of data sets 20 whose mutual similarity is high are arranged immediately below a same data set 20.

First, the data insertion unit 2020 determines, from among the data sets 20 in the first layer, a data set 20 indicating representative data whose similarity to data 40 is highest. Further, the data insertion unit 2020 determines, from among the data sets 20 in the second layer immediately below the determined data set 20, a data set 20 indicating representative data whose similarity to the data 40 is highest. Further, the data insertion unit 2020 determines, from among the data sets 20 in the third layer immediately below the determined data set 20, a data set 20 whose similarity to the data 40 is highest. By performing comparison between data 40 and a data set 20 in such order, it is possible to determine a data set 20 whose similarity to the data 40 is highest by performing comparison a number of times (in this example, three times) equal to a depth of hierarchies.

In a case where similarity between a finally determined data set 20 and data 40 is equal to or more than a predetermined threshold value, the data insertion unit 2020 determines the data set 20, as a data set 20 into which the data 40 are to be inserted. On the other hand, in a case where similarity between a finally determined data set 20 and data 40 is less than the predetermined threshold value, the data insertion unit 2020 determines that, within the tree structure data 10, there is no data set 20 into which the data 40 are to be inserted.

When it is determined that, within the tree structure data 10, there is no data set 20 into which data 40 are to be inserted, the data insertion unit 2020 performs comparison between representative data of each of the data sets 20 stored in the second storage region 60, and the data 40. When there is a data set 20, within the second storage region 60, whose similarity to the data 40 is equal to or more than a predetermined threshold value, the data insertion unit 2020 determines the data set 20, as a data set 20 into which the data 40 are to be inserted. On the other hand, when there is no data set 20, within the second storage region 60, whose similarity to the data 40 is equal to or more than the predetermined threshold value, the data insertion unit 2020 determines that, within the second storage region 60, there is no data set 20 into which the data 40 are to be inserted. In this case, both within the first storage region 50 and the second storage region 60, there is no data set 20 into which the data 40 are to be inserted.

<Insertion of Data 40 into Existing Data Set 20: S106>

In a case where there is a data set 20 into which data 40 are to be inserted (S104: YES), the data insertion unit 2020 inserts the data 40 into the data set 20 (S106). Note that, an existing technique can be used as a technique for inserting new data into a data set.

Herein, in a case where data 40 are inserted into the tree structure data 10, reconfiguration of the tree structure data 10 (change of a structure) may be necessary. For example, in a case where a position of each of the data sets 20 in the tree structure data 10 is determined based on representative data of a data set 20, an appropriate position of each of the data sets 20 may change by change of representative data regarding a data set 20 into which data 40 are inserted.

In such a case, the data management apparatus 2000 may or may not perform reconfiguration of the tree structure data 10. Note that, an existing technique can be used as a technique for performing reconfiguration of a tree structure in response to addition of an element to tree structure data.

### <Generation of New Data Set 20 and Insertion of Data 40: S108>

In a case where there is no data set 20 into which data 40 are to be inserted (S104: NO), the data insertion unit 2020 generates a new data set 20 in the second storage region 60, and inserts the data 40 into the generated data set 20 (S108). Herein, an existing technique can be used as a technique for generating a new data set in a specific storage region, and inserting data into the generated data set.

### <Determination on Insertion Condition: S110, S112>

The set insertion unit 2040 determines whether an insertion condition is satisfied (S110). In a case where the insertion condition is satisfied, the set insertion unit 2040 inserts, into the tree structure data 10, one or more of the data sets 20 stored in the second storage region 60 (S112). Specifically, the insertion condition is a condition in which a data set 20 managed outside the tree structure data 10 is triggered to be added to the tree structure data 10.

Herein, it is assumed that a data set 20 into which data 40 are inserted by the data insertion unit 2020 is a data set 20 included in the tree structure data 10. In this case, there is no change in a data set 20 stored in the second storage region 60. Therefore, it is conceived that the insertion condition is not satisfied. In view of this, in a case where a data set 20 into which data 40 are inserted by the data insertion unit 2020 is a data set 20 included in the tree structure data 10, the data insertion unit 2020 does not have to determine whether the insertion condition is satisfied (is allowed to end the processing of the flowchart in FIG. 4 without executing S110).

A variety of conditions may be adopted as the insertion condition. For example, the insertion condition is a condition that a size of a certain data set 20 stored in the second storage region 60 is equal to or more than a threshold value. Further, the number of pieces of data included in a data set 20 may be used, in place of a size of a data set 20. The threshold value is stored in advance in a storage apparatus accessible from the set insertion unit 2040.

In a case where this insertion condition is satisfied, the set insertion unit 2040 inserts, into the tree structure data 10, a data set 20 whose size or number of pieces of data becomes equal to or more than the threshold value. Note that, a data set 20 whose size or number of pieces of data changes by insertion of data 40 is a data set 20 into which the data 40 are inserted by the data insertion unit 2020. Therefore, in a case where the above-described insertion condition is adopted, the set insertion unit 2040 compares the size or the number of pieces of data with the threshold value regarding a data set 20 into which the data 40 are inserted by the data insertion unit 2020, and inserts, into the tree structure data 10, the data set 20 when the size or the number of pieces of data becomes equal to or more than the threshold value.

In addition to the above, for example, the insertion condition is a condition that dispersion of data 40 included in a certain data set 20 stored in the second storage region 60 is equal to or less than a predetermined threshold value. In a case where this insertion condition is adopted, the set insertion unit 2040 inserts, into the tree structure data 10, a data set 20 in which dispersion of data 40 becomes equal to or less than the predetermined threshold value. Note that, a data set 20 in which dispersion of data 40 changes by insertion of data 40 is a data set 20 into which the data 40 are inserted by the data insertion unit 2020. Therefore, also in a case where this insertion condition is adopted, the set insertion unit 2040 computes dispersion of data 40 included in a data set 20 into which data 40 are inserted by the data insertion unit 2020 regarding the data set 20, and inserts the data set 20 into the tree structure data 10, when the computed dispersion becomes equal to or less than the threshold value.

However, in a case where the number of pieces of data 40 included in a data set 20 is less, dispersion of data 40 included in the data set 20 is affected by data 40 to be newly inserted, and a value of the dispersion is likely to change. In view of the above, a condition that satisfies both of a condition that “dispersion of data 40 included in a data set 20 is equal to or less than a predetermined threshold value”, and a condition “the number of data sets 20 is equal to or more than a threshold value” may be set as the insertion condition. For example, first, the set insertion unit 2040 determines, regarding a data set 20 into which data 40 are inserted, whether the number of pieces of data 40 included in the data set 20 is equal to or more than a threshold value. When it is determined that the number of data sets 20 is equal to or more than a threshold value, the set insertion unit 2040 further determines whether dispersion of data 40 included in the data set 20 is equal to or less than a threshold value. When it is determined that dispersion of data 40 included in the data set 20 is equal to less than the threshold value, the set insertion unit 2040 inserts the data set 20 into the tree structure data 10.

In addition to the above, for example, as the insertion condition, it is possible to adopt a condition that the number of data sets 20 stored in the second storage region 60 becomes equal to or more than a threshold value, or a condition that a total size of a data set 20 stored in the second storage region 60 becomes equal to or more than a threshold value. In a case where these insertion conditions are adopted, the set insertion unit 2040 selects, from among the data sets 20 stored in the second storage region 60, one or more data sets 20 to be inserted into the tree structure data 10, based on a selection rule. The selection rule is a rule serving as a criterion based on which a data set 20 to be inserted into the tree structure data 10 is selected.

Herein, preferably, a data set 20 to be inserted into the tree structure data 10 may have a low probability that a property of the data set 20 changes from now on. This is because an insertion position of a data set 20 in tree structure data 10 is determined depending on a property of the data set 20 (e.g., representative data, dispersion of data, or the like), and therefore, in a case where the property changes from now on, a probability that the position of the data set 20 within the tree structure data 10 is not an appropriate position any more is high. In other words, in a case where a probability that a property of a data set 20 changes from now on is low, it can be said that a probability that an insertion position of a data set 20 determined based on a property of a current data set 20 is continued to be an appropriate position regarding the data set 20 from now on is high. Note that, although it is possible to reconfigure tree structure data, it can be said that appropriateness of an insertion position is important, since it is preferable to suppress a computation cost by reducing a frequency of reconfiguration.

As a selection rule based on which selection of a data set 20 whose probability that a property of the data set 20 changes from now on is low is achieved, for example, the following rules are cited.

(1) A data set 20 within a predetermined ranking is selected in the descending order of the number of pieces of data 40,
(2) a data set 20 within a predetermined ranking is selected in the descending order of a size,
(3) a data set 20 within a predetermined ranking is selected in the order of early generation time,
(4) a data set 20 within a predetermined ranking is selected in the order of early final update time,
(5) a data set 20 within a predetermined ranking is selected in the ascending order of a magnitude of dispersion of data 40, and
(6) a data set 20 within a predetermined ranking is selected in the descending order of a score computed by using a plurality of indexes.

Hereinafter, each of the above-described six examples is described.

### <<Regarding (1)>>

The set insertion unit 2040 selects a data set 20 within a predetermined ranking in the descending order of the number of pieces of data 40. For example, it is assumed that the predetermined ranking is a second place. In this case, the set insertion unit 2040 selects, from among the data sets 20 stored in the second storage region 60, a data set 20 in which the number of pieces of data 40 is largest, and a data set 20 in which the number of pieces of data 40 is second largest.

Herein, it can be said that the more the number of pieces of data 40 included in a data set 20, the higher a probability that a property of data set 20 is sufficiently expressed by these pieces of data 40. Therefore, by preferentially inserting, into the tree structure data 10, a data set 20 in which the number of pieces of data 40 is large, it is possible to insert a data set 20 at an appropriate position within the tree structure data 10.

### <<Regarding (2)>>

The set insertion unit 2040 selects a data set 20 within a predetermined ranking in the descending order of a size. For example, it is assumed that the predetermined ranking is a second place. In this case, the set insertion unit 2040 selects, from among the data sets 20 stored in the second storage region 60, a data set 20 in which a total of sizes (sizes of data 40 included in a data set 20) is largest, and a data set 20 in which a total size of data 40 is second largest.

Herein, it can be said that the larger the size of data 40 included in a data set 20, the higher a probability that a property of a data set 20 is sufficiently expressed by these pieces of data 40. Therefore, by preferentially inserting, into the tree structure data 10, a data set 20 in which a total size of data 40 is large, it is possible to insert a data set 20 at an appropriate position within the tree structure data 10.

### <<Regarding (3)>>

The set insertion unit 2040 selects a data set 20 within a predetermined ranking in the order of early generation time. For example, it is assumed that the predetermined ranking is a second place. In this case, the set insertion unit 2040 selects, from among the data sets 20 stored in the second storage region 60, a data set 20 whose generation time is earliest (an elapsed time from generation is longest), and a data set 20 whose generation time is second earliest.

Herein, it is conceived that the shorter an elapsed time from generation of a data set 20, the higher a probability that a property of a data set 20 changes by insertion of new data 40 into the data set 20. In other words, it is conceived that the longer an elapsed time from generation of a data set 20, the lower a probability that a property of a data set 20 changes by insertion of new data 40. Therefore, by preferentially inserting, into the tree structure data 10, a data set 20 whose elapsed time from generation is long, it is possible to insert a data set 20 at an appropriate position within the tree structure data 10.

### <<Regarding (4)>>

The set insertion unit 2040 selects a data set 20 within a predetermined ranking in the order of early final update time (time when new data 40 are inserted). For example, it is assumed that the predetermined ranking is a second place. In this case, the set insertion unit 2040 selects, from among the data sets 20 stored in the second storage region 60, a data set 20 whose update time is earliest (an elapsed time from final updating is longest), and a data set 20 whose update time is second earliest.

Herein, it is conceived that the longer an elapsed time from updating of a data set 20, the lower a probability of updating thereafter. Therefore, the longer an elapsed time from updating of a data set 20, the lower a probability that a property of a data set 20 changes thereafter. Therefore, by preferentially inserting, into the tree structure data 10, a data set 20 whose elapsed time from updating is long, it is possible to insert a data set 20 at an appropriate position within the tree structure data 10.

### <<Regarding (5)>>

The set insertion unit 2040 selects a data set 20 within a predetermined ranking in the ascending order of a magnitude of dispersion of data 40 included in the data set 20. For example, it is assumed that the predetermined ranking is a second place. In this case, the set insertion unit 2040 selects, from among the data sets 20 stored in the second storage region 60, a data set 20 in which dispersion of data 40 is smallest, and a data set 20 in which dispersion of data 40 is second smallest.

However, as described above, in a case where the number of pieces of data 40 included in a data set 20 is less, dispersion of data 40 included in the data set 20 is affected by data 40 to be newly inserted, and is likely to change. Specifically, a data set 20 in which the number of pieces of data 40 is less has a possibility that a property of the data set 20 becomes unstable, even when dispersion of data 40 is small.

In view of the above, for example, the set insertion unit 2040 may extract, from the data sets 20, a data set 20 in which the number of pieces of data 40 is equal to or more than a threshold value, and select a data set 20, taking into consideration dispersion of data 40 by using only the extracted data set 20 as a target. Specifically, first, the set insertion unit 2040 extracts, from among the data sets 20, a data set 20 in which the number of pieces of data 40 included in the data set 20 is equal to or more than a threshold value. Next, the set insertion unit 2040 selects, from the extracted data set 20, a data set 20 within a predetermined ranking in the ascending order of a magnitude of dispersion of data 40 included in the extracted data set 20.

### <<Regarding (6)>>

In addition to the above, for example, the set insertion unit 2040 may compute a score of each data set 20 by using a plurality of indexes such as “the number of pieces of data 40”, “a size”, “a generation time”, “a final update time”, and “dispersion of data 40” cited above, and select a data set 20 within a predetermined ranking in the descending order of a computed score. For example, the set insertion unit 2040 computes the following score by using the above-described five indexes.

$$\begin{matrix}[ Formula 1 ] & \\ {S}_{i} = {\sum }_{j = 1}^{5} {f}_{j} ( {x}_{ij} ) & ( 1 )\end{matrix}$$

Herein, i is an identifier of a data set 20. xi1, xi2, xi3, xi4, and xi5 are respectively the number of pieces of data 40, a size, a generation time, a final update time, and dispersion of data 40 in a data set 20 whose identifier is i. f1(xi1) is a monotonous non-decreasing function regarding the number xi1 of pieces of data 40. f2(xi2) is a monotonous non-decreasing function regarding the size xi2. f3(xi3) is a monotonous non-increasing function regarding the generation time xi3. f4(xi4) is a monotonous non-increasing function regarding the final update time xi4. f5(xi5) is a monotonous non-increasing function regarding the dispersion xi5 of data 40.

<Insertion of Data Set 20 into Tree Structure Data 10: S112>

The set insertion unit 2040 inserts, into the tree structure data 10, one or more of the data sets 20 stored in the second storage region 60. Herein, an existing technique can be used as a technique for inserting data (a data set 20 in the tree structure data 10) serving as an element with respect to data of a tree structure. Hereinafter, a case is exemplified in which a data set 20 is inserted into the tree structure data 10 achieved as a similarity tree.

For example, it is assumed that the tree structure data 10 are a similarity tree having the above-described structure illustrated in FIG. 6. In this case, the set insertion unit 2040 determines, from among the data sets 20 in the first layer, a data set 20 having representative data whose similarity to representative data of a data set 20 being an insertion target is largest. Further, the set insertion unit 2040 determines, from among the data sets 20 in the second layer immediately below the determined data set 20, a data set 20 having representative data whose similarity to the representative data of the data set 20 being the insertion target is largest. Then, the set insertion unit 2040 inserts the data set 20 being the insertion target at a position immediately below the determined data set 20.

Note that, it is preferable to delete, from the second storage region 60, a data set 20 inserted into the tree structure data 10. However, a data set 20 may be deleted at an appropriate timing thereafter, in place of deleting a data set 20 immediately after insertion into the tree structure data 10. For example, a data set 20 may be deleted by overwriting the data set 20 to be deleted by a new data set 20 at a time of generating the new data set 20 in the second storage region 60.

### <Use Method of Managed Data>

A use method of data managed by the data management apparatus 2000 is exemplified. For example, the data management apparatus 2000 acquires a retrieval query indicating a data set 20, and determines and outputs, from among the data sets 20 included in the first storage region 50 and the second storage region 60, a data set 20 whose property is similar to the data set 20 indicated by the retrieval query (whose similarity to the data set 20 is equal to or more than a predetermined threshold value). Thus, it is possible to easily search, from among the data sets 20 managed by the data management apparatus 2000, a data set whose property is similar to the data set 20 indicated by the retrieval query.

Processing of a retrieval query is performed as follows, for example. First, the data management apparatus 2000 retrieves the tree structure data 10 by way of a data set 20 indicated by a retrieval query. When there is, within the tree structure data 10, a data set 20 whose similarity to the data set 20 indicated by the retrieval query is equal to or more than a predetermined threshold value, the data set 20 is determined as a data set 20 corresponding to the retrieval query (data set 20 whose property is similar to the data set 20 indicated by the retrieval query). On the other hand, when there is, within the tree structure data 10, no data set 20 whose similarity to the data set 20 indicated by the retrieval query is equal to or more than the predetermined threshold value, the data management apparatus 2000 retrieves the second storage region 60.

When there is, within the second storage region 60, a data set 20 whose similarity to the data set 20 indicated by the retrieval query is equal to or more than the predetermined threshold value, the data set 20 is determined as a data set 20 corresponding to the retrieval query. On the other hand, when there is, within the second storage region 60, no data set 20 whose similarity to the data set 20 indicated by the retrieval query is equal to or more than the predetermined threshold value, it is determined that there is no data set 20 corresponding to the retrieval query.

Information to be output from the data management apparatus 2000 as a retrieval result is optional. For example, the data management apparatus 2000 outputs a data set 20 corresponding to a retrieval query. In addition to the above, for example, in a case where certain identification information is allocated to each data set 20 in advance, the data management apparatus 2000 may output identification information of a data set 20 corresponding to a retrieval query.

For example, it is assumed that an image feature of a same person is included in a data set 20. In this case, authentication of a person is performed by using the image feature included in the data set 20, and identification information (such as a name or an identification number) of the authenticated person is allocated to the data set 20. The data management apparatus 2000 is designed to return the identification information, as an output to a retrieval query. Thus, it is possible to easily recognize an image feature of which one of the persons, the data set 20 being a retrieval target represents.

The retrieval query may be the one to be manually input, or may be the one to be input from another apparatus. Herein, a timing at which retrieval is performed regarding a certain data set 20 (timing at which a retrieval query indicating the data set 20 is issued) is optional. For example, the timing is a time when a data set 20 being a retrieval target is generated (such as a time when a set of image features of a same person is acquired by analyzing a video), a time when data 40 are inserted into a data set 20 being a retrieval target, a time when a data set 20 being a retrieval target is completed (e.g., a time when it is determined that data 40 are not inserted into the data set 20 for a predetermined period of time), a time when the number of elements in a data set 20 being a retrieval target reaches a predetermined number, a time when dispersion of similarity between data 40 included in a data set 20 being a retrieval target becomes equal to or less than a predetermined value, or the like. Alternatively, in a case where processing load of the data management apparatus 2000 is high at each of the above-described timings (in a case where a use rate of a computer resource such as a CPU is equal to or more than a threshold value), a retrieval timing may be shifted until the processing load of the data management apparatus 2000 is lowered (until the use rate of a computer resource becomes less than the threshold value).

Herein, a function of inserting a data set 20 into the data management apparatus 2000 may be achieved by a method similar to the above-described retrieval. Specifically, the data management apparatus 2000 acquires a data set 20 being an insertion target. When there is, within the tree structure data 10 or the second storage region 60, a data set 20 whose similarity to the data set 20 being the insertion target is equal to or more than a predetermined threshold value, the data management apparatus 2000 merges the data set 20 and the data set 20 being the insertion target. Thus, it is possible to insert not only data 40 one by one, but also a data set 20 being a set of data 40 all at once.

In the foregoing, an example embodiment according to the present invention has been described with reference to the drawings, however, these are examples of the present invention, and combination of the above-described example embodiments, or various configurations other than the above can also be adopted.

A part or all of the above-described example embodiment may also be described as the following supplementary notes, but is not limited to the following.

1. A data management apparatus being accessible to a first storage region in which tree structure data being data of a tree structure having a data set as a node are stored, and a second storage region in which a data set not being included in the tree structure data is stored; the data management apparatus including:

a data insertion unit that acquires data to be inserted into the data set, and inserts the acquired data into the data set being already stored in the first storage region or the second storage region, or generates a new data set in the second storage region and inserts the acquired data into the generated data set; and

a set insertion unit that inserts, into the tree structure data, one or more of the data sets stored in the second storage region, when a predetermined condition is satisfied regarding the data set stored in the second storage region.

2. The data management apparatus according to supplementary note 1, wherein

the data insertion unit
determines whether there is a data set into which the acquired data are to be inserted,
in a case where there is a data set into which the acquired data are to be inserted, inserts the acquired data into the data set, and,
generates a new data set in the second storage region, and inserts the acquired data into the generated data set, in a case where there is no data set into which the acquired data are to be inserted.
   3. The data management apparatus according to supplementary note 1 or 2, wherein

a plurality of pieces of data to be stored in the one data set are an image feature of a same person extracted from each different image.

4. The data management apparatus according to supplementary notes 1 to 3, wherein

the predetermined condition is that the number of pieces of or a total size of data included in the data set stored in the second storage region becomes equal to or more than a threshold value, and

the set insertion unit inserts, into the tree structure data, the data set in which the number of pieces of or a total size of data becomes equal to or more than a threshold value.

5. The data management apparatus according to supplementary notes 1 to 3, wherein

the predetermined condition is that the number of or a total size of the data set stored in the second storage region becomes equal to or more than a threshold value, and,

when the predetermined condition is satisfied, the set insertion unit selects one or more of the plurality of data sets stored in the second storage region, based on a selection rule, and inserts the selected data set into the tree structure data.

6. The data management apparatus according to supplementary note 5, wherein

the selection rule is
selecting the data set within a predetermined ranking in the descending order of the number of pieces of data,
selecting the data set within a predetermined ranking in the descending order of a size,
selecting the data set within a predetermined ranking in the order of early generation time,
selecting the data set within a predetermined ranking in the order of early final update time, or
selecting the data set within a predetermined ranking in the ascending order of a magnitude of dispersion of data.
   7. A control method to be executed by a computer,

the computer being accessible to a first storage region in which tree structure data being data of a tree structure having a data set as a node are stored, and a second storage region in which a data set not being included in the tree structure data is stored,

the control method including:

a data insertion step of acquiring data to be inserted into the data set, and inserting the acquired data into the data set being already stored in the first storage region or the second storage region, or generating a new data set in the second storage region and inserting the acquired data into the generated data set; and

a set insertion step of inserting, into the tree structure data, one or more of the data sets stored in the second storage region, when a predetermined condition is satisfied regarding the data set stored in the second storage region.

8. The control method according to supplementary note 7, further including:

in the data insertion step,
determining whether there is a data set into which the acquired data are to be inserted;
in a case where there is a data set into which the acquired data are to be inserted, inserting the acquired data into the data set; and,
in a case where there is no data set into which the acquired data are to be inserted, generating a new data set in the second storage region, and inserting the acquired data into the generated data set.
   9. The control method according to supplementary note 7 or 8, wherein

a plurality of pieces of data to be stored in the one data set are an image feature of a same person extracted from each different image.

10. The control method according to supplementary notes 7 to 9, wherein

the predetermined condition is that the number of pieces of or a total size of data included in the data set stored in the second storage region becomes equal to or more than a threshold value, and

the control method further including,

in the set insertion step, inserting, into the tree structure data, the data set in which the number of pieces of or a total size of data becomes equal to or more than a threshold value.

11. The control method according to supplementary notes 7 to 9, wherein

the predetermined condition is that the number of or a total size of the data set stored in the second storage region becomes equal to or more than a threshold value, and

the control method further including,

in the set insertion step, when the predetermined condition is satisfied, selecting one or more of the plurality of data sets stored in the second storage region, based on a selection rule, and inserting the selected data set into the tree structure data.

12. The control method according to supplementary note 11, wherein

the selection rule is
selecting the data set within a predetermined ranking in the descending order of the number of pieces of data,
selecting the data set within a predetermined ranking in the descending order of a size,
selecting the data set within a predetermined ranking in the order of early generation time,
selecting the data set within a predetermined ranking in the order of early final update time, or
selecting the data set within a predetermined ranking in the ascending order of a magnitude of dispersion of data.
   13. A program causing a computer to execute each step of the control method according to any one of supplementary notes 7 to 12.

This application is based upon and claims the benefit of priority from Japanese patent application No. 2019-098792, filed on May 27, 2019, the disclosure of which is incorporated herein in its entirety by reference.

What is claimed is:

1. A data management apparatus being accessible to a first storage region in which tree structure data being data of a tree structure having a data set as a node are stored, and a second storage region in which a data set not being included in the tree structure data is stored; the data management apparatus comprising:
at least one memory configured to store one or more instructions; and
at least one processor configured to execute the one or more instructions to:
acquire data to be inserted into the data set;
perform insertion of the acquired data into the data set being already stored in the first storage region or the second storage region, or generation of a new data set in the second storage region and insertion of the acquired data into the generated data set; and
insert, into the tree structure data, one or more of the data sets stored in the second storage region, when a predetermined condition is satisfied regarding the data set stored in the second storage region.

2. The data management apparatus according to claim 1,
wherein the at least one processor is further configured to execute the one or more instructions to:
determine whether there is a data set into which the acquired data are to be inserted,
in a case where there is a data set into which the acquired data are to be inserted, insert the acquired data into the data set, and,
generate a new data set in the second storage region, and insert the acquired data into the generated data set, in a case where there is no data set into which the acquired data are to be inserted.

3. The data management apparatus according to claim 1, wherein
a plurality of pieces of data to be stored in the one data set are an image feature of a same person extracted from each different image.

4. The data management apparatus according to claim 1,
wherein the predetermined condition is that the number of pieces of or a total size of data included in the data set stored in the second storage region becomes equal to or more than a threshold value, and
wherein the at least one processor is further configured to execute the one or more instructions to insert, into the tree structure data, the data set in which the number of pieces of or a total size of data becomes equal to or more than a threshold value.

5. The data management apparatus according to claim 1,
wherein the predetermined condition is that the number of or a total size of the data set stored in the second storage region becomes equal to or more than a threshold value, and,
wherein the at least one processor is further configured to execute the one or more instructions to select, when the predetermined condition is satisfied, one or more of the plurality of data sets stored in the second storage region, based on a selection rule, and insert the selected data set into the tree structure data.

6. The data management apparatus according to claim 5, wherein
the selection rule is
selecting the data set within a predetermined ranking in a descending order of the number of pieces of data,
selecting the data set within a predetermined ranking in a descending order of a size,
selecting the data set within a predetermined ranking in an order of early generation time,
selecting the data set within a predetermined ranking in an order of early final update time, or
selecting the data set within a predetermined ranking in an ascending order of a magnitude of dispersion of data.

7. A control method to be executed by a computer,
the computer being accessible to a first storage region in which tree structure data being data of a tree structure having a data set as a node are stored, and a second storage region in which a data set not being included in the tree structure data is stored,
the control method comprising:
acquiring data to be inserted into the data set;
performing insertion of the acquired data into the data set being already stored in the first storage region or the second storage region, or generation of a new data set in the second storage region and insertion of the acquired data into the generated data set; and
inserting, into the tree structure data, one or more of the data sets stored in the second storage region, when a predetermined condition is satisfied regarding the data set stored in the second storage region.

8. A non-transitory storage medium storing a program causing a computer being accessible to a first storage region in which tree structure data being data of a tree structure having a data set as a node are stored, and a second storage region in which a data set not being included in the tree structure data is stored to:
acquire data to be inserted into the data set;
performing insertion of the acquired data into the data set being already stored in the first storage region or the second storage region, or generation of a new data set in the second storage region and insertion of the acquired data into the generated data set; and
insert, into the tree structure data, one or more of the data sets stored in the second storage region, when a predetermined condition is satisfied regarding the data set stored in the second storage region.
